(19) United States
(12) Patent Application Publication
(10) Pub. No.: US 2024/0340565 A1
(43) Pub. Date: Oct. 10, 2024

(54) SPEAKER MODULE FOR AN INFORMATION HANDLING SYSTEM

(71) Applicant: Dell Products L.P., Round Rock, TX (US)

(72) Inventors: CHIA-HUNG SHIH, Taipei City (TW); CHIN-CHUNG WU, New Taipei City (TW); CHIEN-YU HUANG, New Taipei City (TW); CHUN-KAI TZENG, Keelung City (TW)

(21) Appl. No.: 18/295,287

(22) Filed: Apr. 4, 2023

(51) Int. Cl. H04R 1/02; H04R 1/28

(52) U.S. Cl. CPC H04R 1/021; H04R 1/025; H04R 1/288

(57) ABSTRACT

A speaker module, including: a speaker enclosure, including: a recessed portion; a transducer, including: a top surface; a bottom surface; a perimeter surface positioned between the top surface and the bottom surface; a rubber cap including: a top side; a bottom side; and edges extending between the top side and the bottom side, wherein the edges define an inside perimeter of the rubber cap and include a slot extending along the inside perimeter of the rubber cap, wherein, the transducer is coupled to the rubber cap such that the rubber cap surrounds the transducer and the perimeter surface of the transducer is positioned within the slot of the plurality of edges of the rubber cap, wherein, the transducer is coupled to the speaker enclosure such that the transducer is positioned within the recessed portion of the speaker enclosure and the rubber cap is positioned between the transducer and the speaker.

### BACKGROUND

### Field of the Disclosure

The disclosure relates generally to an information handling system, and in particular, a speaker module for an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

Innovative aspects of the subject matter described in this specification may be embodied in a speaker module for an information handling system, including a speaker enclosure, including: a recessed portion; a transducer, including: a top surface; a bottom surface positioned opposite to the top surface; a perimeter surface positioned between the top surface and the bottom surface; a rubber cap including: a top side; a bottom side positioned opposite to the top side; and a plurality of edges extending between the top side and the bottom side, wherein the plurality of edges define an inside perimeter of the rubber cap and include a slot extending along the inside perimeter of the rubber cap, wherein, the transducer is coupled to the rubber cap such that the rubber cap surrounds the transducer and the perimeter surface of the transducer is positioned within the slot of the plurality of edges of the rubber cap, wherein, the transducer is coupled to the speaker enclosure such that the transducer is positioned within the recessed portion of the speaker enclosure and the rubber cap is positioned between the transducer and the speaker.

Other embodiments of these aspects include corresponding systems and apparatus.

These and other embodiments may each optionally include one or more of the following features. For instance, the plurality of edges further define an outside perimeter of the rubber cap, the recessed portion of the speaker enclosure includes a plurality of walls, and transducer is coupled to the speaker enclosure such that the transducer is positioned within the recessed portion of the speaker enclosure and the outside perimeter of the rubber cap is in contact with the plurality of walls of the recessed portion to position the rubber cap between the transducer and the speaker enclosure. The transducer further includes a diaphragm, wherein the top side of the rubber cap includes an egress, and wherein the transducer is coupled to the rubber cap such that the diaphragm of the transducer is positioned within the egress of the top side of the rubber cap. The transducer is coupled to the speaker enclosure such that the transducer is positioned within the recessed portion of the speaker enclosure and the outside perimeter of the rubber cap is in contact with the plurality of walls of the recessed portion to position the rubber cap between the transducer and the speaker to dampen vibrations of the speaker enclosure that are generated by the transducer. The transducer is coupled to the speaker enclosure such that the transducer lays in a first plane angled with respect to a second plane the speaker enclosure lays in. The rubber cap further includes microinjections of a gas. The gas is nitrogen. The rubber cap further includes molding springs positioned within the edges of the rubber cap to apply an elastic force of the rubber cap against the transducer.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates an environment including an information handling system.

FIG. 3 illustrates a perspective view of the information handling system.

FIG. 4 illustrates a bottom view of a second body of the information handling system.

FIG. 5 illustrates a perspective view of the transducer.

FIG. 6 illustrates a perspective view of the rubber cap.

FIG. 7 illustrates a perspective view of the transducer coupled to the rubber cap.

FIG. 8 illustrates a bottom view of the second body of the information handling.

FIG. 9 illustrates a cut-away side view of the speaker module.

FIG. 10 illustrates a cross-sectional view of the rubber cap coupled to the transducer.

FIG. 11 illustrates a cross-sectional view of the rubber cap coupled to the transducer.

FIG. 12 illustrates a perspective view of molding springs.

### DESCRIPTION OF PARTICULAR EMBODIMENT(S)

This disclosure discusses a speaker module of an information handling system. In short, a rubber cap coupled to a transducer and the transducer coupled to a speaker enclosure, dampens vibrations of the speaker enclosure that are generated by the transducer, described further herein.

Specifically, this disclosure discusses a speaker module for an information handling system, including: a speaker enclosure, including: a recessed portion, the recessed portion including a plurality of walls; a transducer, including: a top surface; a bottom surface positioned opposite to the top surface; a perimeter surface positioned between the top surface and the bottom surface; a diaphragm; a rubber cap including: a top side including an egress; a bottom side positioned opposite to the top side; and a plurality of edges extending between the top side and the bottom side, wherein a first edge of the plurality of edges is opposite to a third edge of the plurality of edges, and a second edge of the plurality of edges is opposite to a fourth edge of the plurality of edges, wherein the plurality of edges define an inside perimeter of the rubber cap and an outside perimeter of the rubber cap, wherein the plurality of edges include a slot extending along the inside perimeter of the rubber cap, wherein the transducer is coupled to the rubber cap such that i) the rubber cap surrounds the transducer and the perimeter surface of the transducer is positioned within the slot of the plurality of edges of the rubber cap, and ii) the diaphragm of the transducer is positioned within the egress of the top side of the rubber cap, wherein the transducer is coupled to the speaker enclosure such that the transducer is positioned within the recessed portion of the speaker enclosure and the outside perimeter of the rubber cap is in contact with the plurality of walls of the recessed portion to position the rubber cap between the transducer and the speaker enclosure to dampen vibrations of the speaker enclosure that are generated by the transducer.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

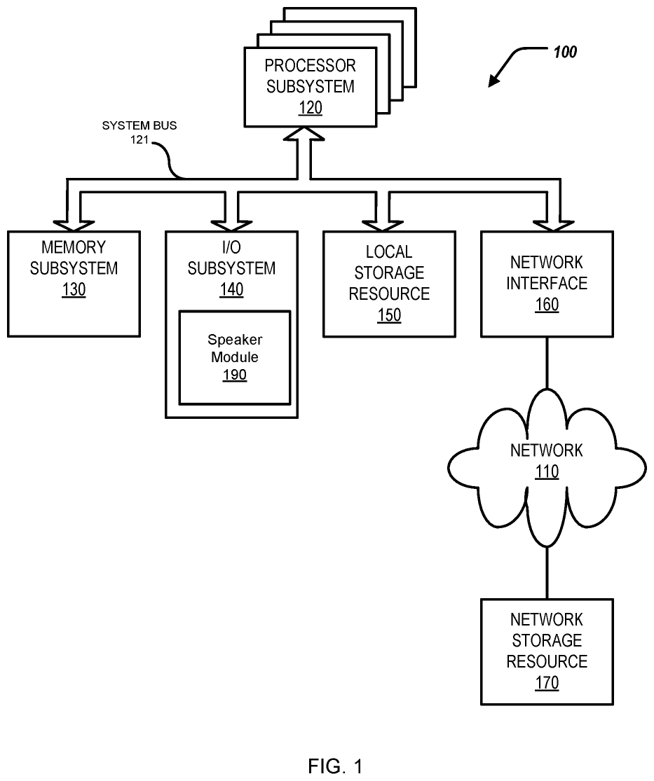

Particular embodiments are best understood by reference to FIGS. 1-12 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, or a camera, or another type of peripheral device.

The I/O subsystem 140 can further include a speaker module 190.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other type of rotating storage media, flash memory, EEPROM, and/or other type of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g. corporate) network. The network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g. customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

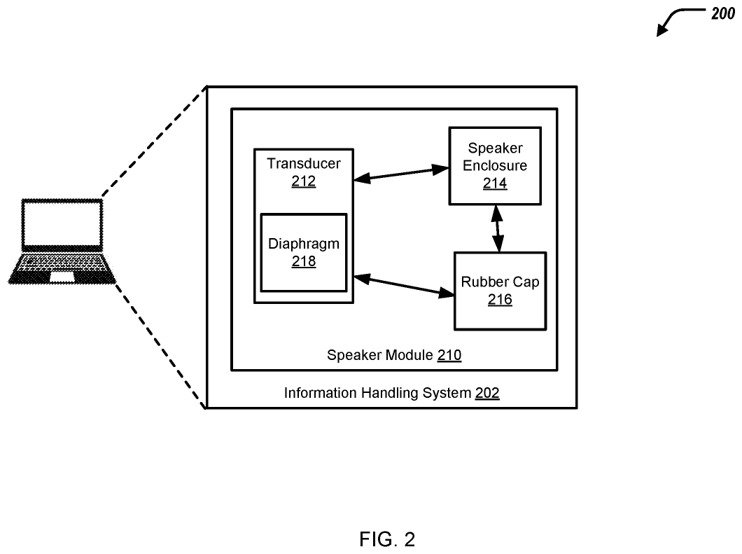

Turning to FIG. 2, FIG. 2 illustrates an environment 200 including an information handling system 202. The information handling system 202 can include a speaker module 210. In some examples, the information handling system 202 is similar to, or includes, the information handling system 100 of FIG. 1. In some examples, the speaker module 210 is the same, or substantially the same, as the speaker module 190 of FIG. 1.

The speaker module 210 can include a transducer 212, a speaker enclosure 214, and a rubber cap 216. The transducer 212 can include a diaphragm 218.

The rubber cap 216 can be coupled to the transducer 212, described further herein. The transducer 212 can be coupled to the speaker enclosure 214, described further herein.

The rubber cap 216, when coupled to the transducer 212 and when the transducer 212 is coupled to the speaker enclosure 214, dampens vibrations of the speaker enclosure 214 that are generated by the transducer 212, described further herein.

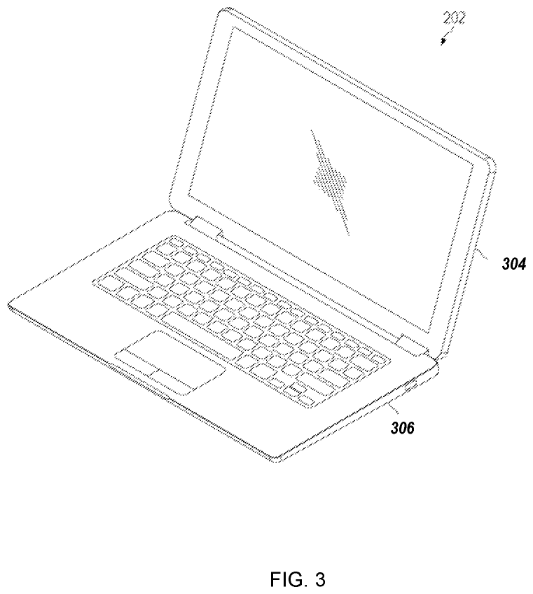

FIG. 3 illustrates a perspective view of the information handling system 202. The information handling system 202 can include a first body 304 and a second body 306. In some examples, the information handling system 202 is similar to, or includes, the information handling system 100 of FIG. 1.

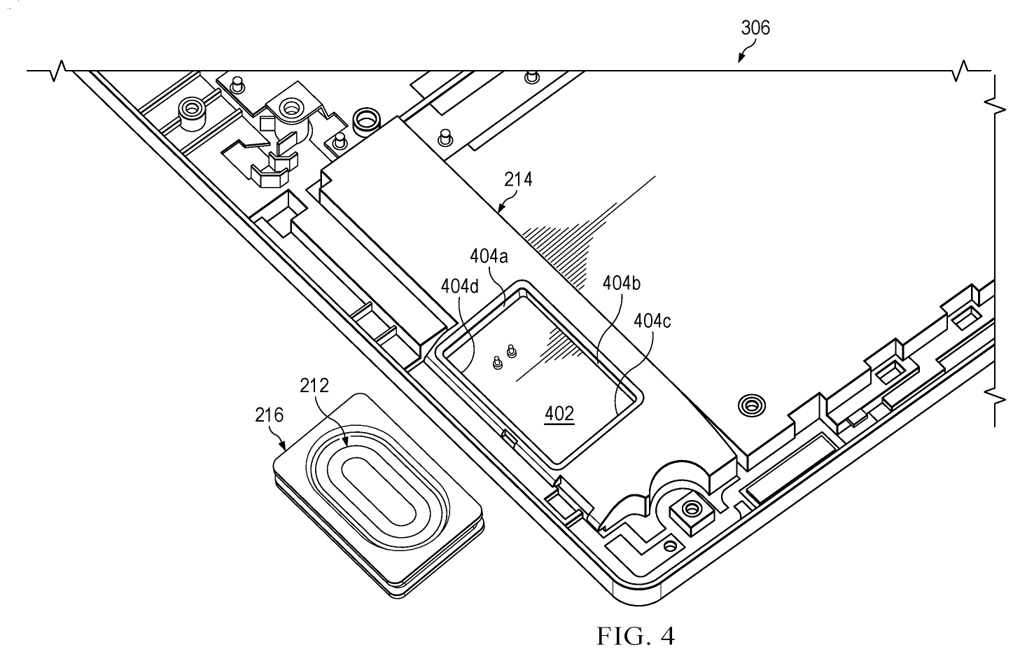

FIG. 4 illustrates a bottom view of the second body 306 of the information handling system 202. The second body 306 of the information handling system 202 can include the speaker enclosure 214. The speaker enclosure 214 can include a recessed portion 402. The recessed portion 402 can include a plurality of walls, shown as wall 404a, 404b, 404c, 404d (collectively referred to as walls 404).

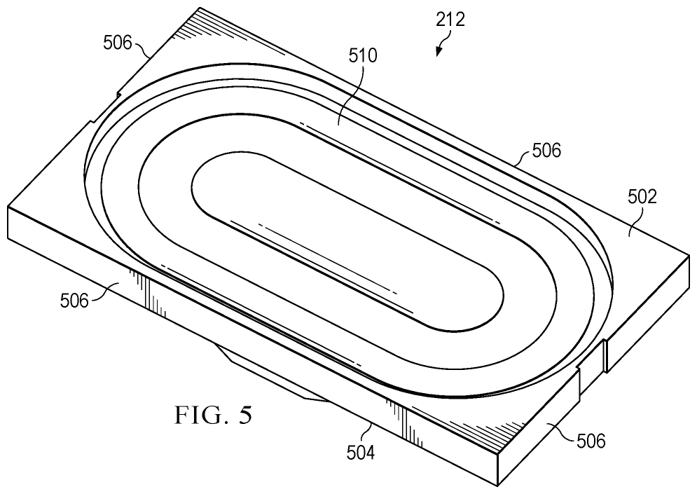

FIG. 5 illustrates a perspective view of the transducer 212. The transducer 212 can include a top surface 502 and a bottom surface 504. The bottom surface 504 is opposite to the top surface 502. A perimeter 506 (or perimeter surface 506) can be positioned between the top surface 502 and the bottom surface 504. The transducer 212 can further include a diaphragm 510. The diaphragm 510 can be positioned on the top surface 502 of the transducer 212.

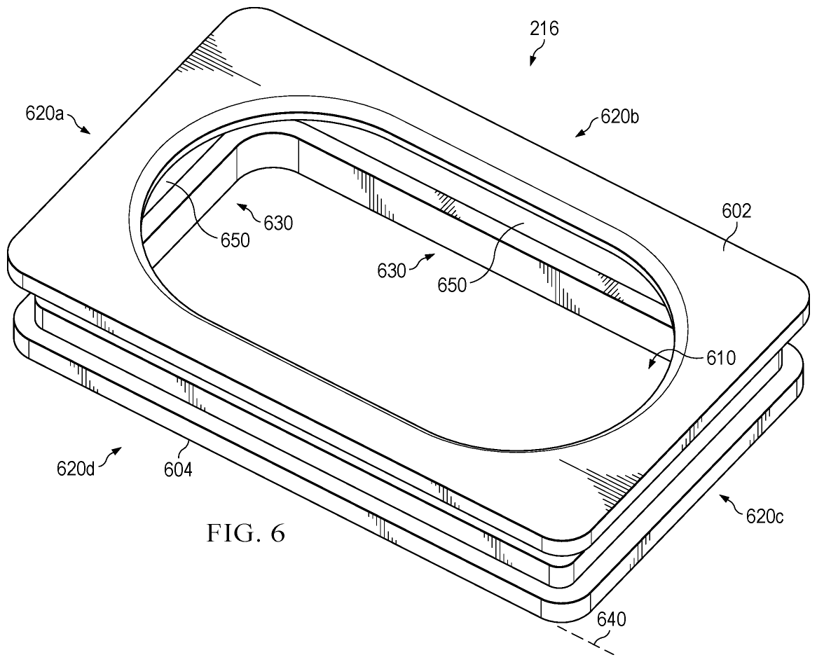

FIG. 6 illustrates a perspective view of the rubber cap 216. The rubber cap 216 can include a top side 602 and a bottom side 604. The bottom side 604 is opposite to the top side 602. The rubber cap 216 includes an egress 610. Specifically, the egress 610 can extend through the top side 602 of the rubber cap 216 to the bottom side 604 of the rubber cap 216.

The rubber cap 216 can further include a first edge 620a, a second edge 620b, a third edge 620c, and a fourth edge 620d (collectively referred to as edges 620). The edges 620 extend between the top side 602 of the rubber cap 216 and the bottom side 604 of the rubber cap 216. The first edge 620a can be opposite to the third edge 620c; and the second edge 620b can be opposite to the fourth edge 620d. The edges 620 define an insider perimeter 630 of the rubber cap 216. Further, the edges 620 define an outside perimeter 640 of the rubber cap 216.

The edges 620 can include a slot 650 extending along the inside perimeter 630 of the rubber cap 216.

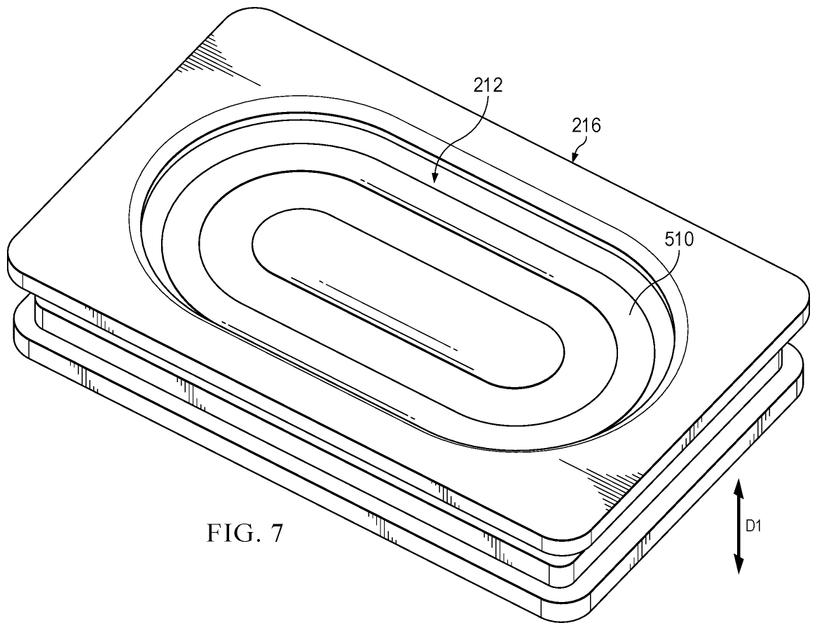

FIG. 7 illustrates a perspective view of the transducer 212 coupled to the rubber cap 216. Referring to FIGS. 5-7, to that end, when the rubber cap 216 is coupled to the transducer 212, the rubber cap 216 surrounds the transducer 212. That is, the rubber cap 216 surrounds the transducer 212 such that the perimeter surface 506 of the transducer 212 is positioned within the slot 650 of the edges 620 of the rubber cap 216. That is, the edges 620 of the rubber cap 216 at the internal perimeter 630 of the rubber cap 216 are touching the perimeter surface 506 of the transducer 212. Moreover, when the rubber cap 216 is coupled to the transducer 212, the diaphragm 510 of the transducer 212 is positioned within the egress 610 of the rubber cap 216. That is, the diaphragm 510 of the transducer 212 is positioned within the egress 610 at the top side 602 of the rubber cap 216.

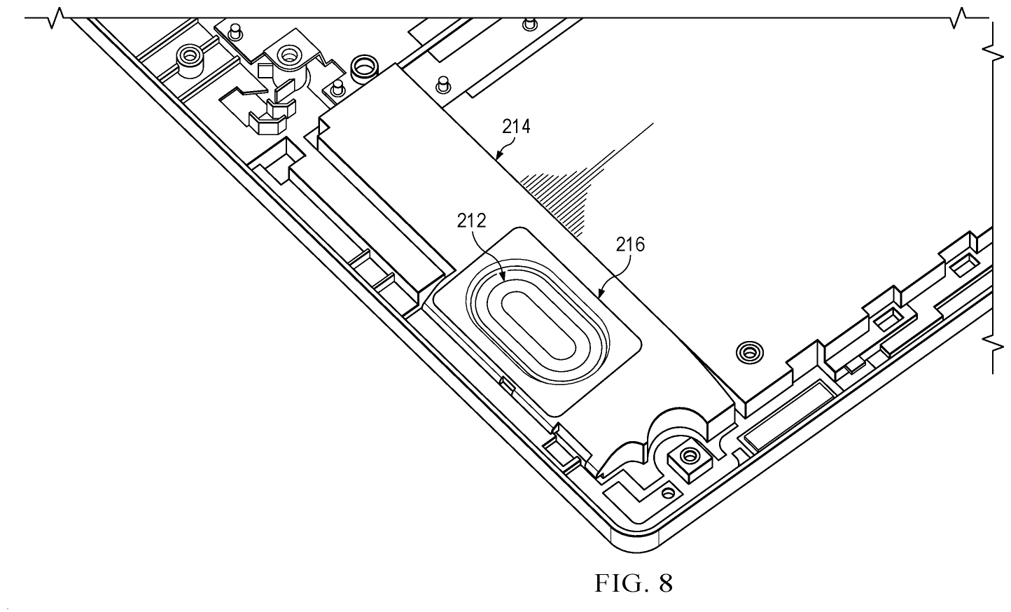

FIG. 8 illustrates a bottom view of the second body 306 of the information handling system 202. Specifically, the transducer 212 is coupled to the speaker enclosure 214. Referring to FIGS. 4, 6, and 8, when the transducer 212 is coupled to the speaker enclosure 214 (as shown in FIG. 8), the transducer 212 is positioned within the recessed portion 402 of the speaker enclosure 214, and further, the rubber cap 216 coupled to the transducer 212 is also positioned within the recessed portion 402 of the speaker enclosure 214. The transducer 212 is positioned within the recessed portion 402 of the speaker enclosure 214 such that the outside perimeter 640 of the rubber cap 216 is in contact with the walls 404 of the recessed portion 402. That is, in some examples, the edges 620 of the rubber cap 216 at the outside perimeter 640 of the rubber cap 216 are in contact with the walls 404 of the recessed portion 402 of the speaker enclosure 214. Specifically, the edge 620a of the rubber cap 216 is in contact with the wall 404a of the recessed portion 402 of the speaker enclosure 214; the edge 620b of the rubber cap 216 is in contact with the wall 404b of the recessed portion 402 of the speaker enclosure 214; the edge 620c of the rubber cap 216 is in contact with the wall 404c of the recessed portion 402 of the speaker enclosure 214; the edge 620d of the rubber cap 216 is in contact with the wall 404d of the recessed portion 402 of the speaker enclosure 214.

To that end, the transducer 212 is positioned within the recessed portion 402 of the speaker enclosure 214 such that the outside perimeter 640 of the rubber cap 216 is in contact with the walls 404 of the recessed portion 402 to position the rubber cap 216 between the transducer 212 and the speaker enclosure 214. That is, the transducer 212 is separated from the speaker enclosure 214 by the rubber cap 216. Specifically, the transducer 212 is separated from the speaker enclosure 214 by the rubber cap 216 by the edges 620 of the rubber cap 216 contacting the speaker enclosure 214.

When the transducer 212 is positioned within the recessed portion 402 of the speaker enclosure 214 such that the outside perimeter 640 of the rubber cap 216 is in contact with the walls 404 of the recessed portion 402 to position the rubber cap 216 between the transducer 212 and the speaker enclosure 214, the rubber cap 216 dampens vibrations of the speaker enclosure 214 that are generated by the transducer 212. That is, the rubber cap 216 reduces, minimizes, and/or prevents vibrations of the speaker enclosure 214 that are generated by the transducer 212.

Specifically, the transducer 212 can translate along the direction D1, shown in FIG. 7. For example, the transducer 212 can translate along the direction D1 rapidly and over small distances. When the transducer 212 translates over the direction D1 (e.g., rapidly and over small distances), the transducer 212 can impart vibrations to the speaker enclosure 214. The rubber cap 216, by being positioned between the transducer 212 and the speaker enclosure 214 and surrounding the transducer 212, can dampen the vibrations of the speaker enclosure 214 that are generated by the transducer 212. That is, the rubber cap 216 can absorb, at least partially, the vibrations of the speaker enclosure 214 that are generated by the transducer 212.

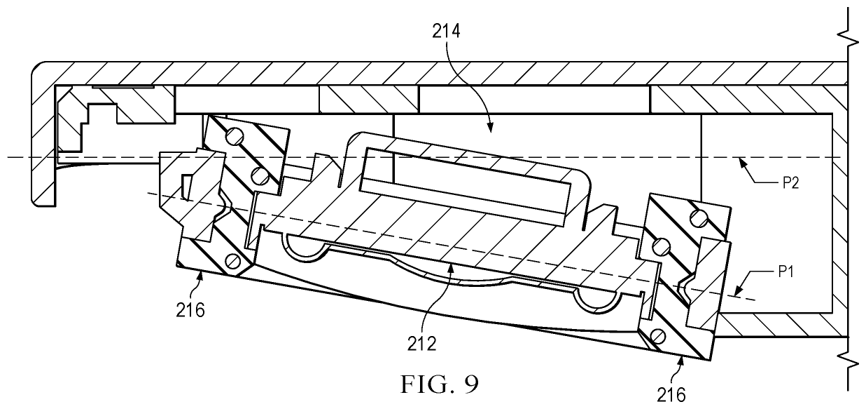

FIG. 9 illustrates a cut-away side view of the speaker module 210. In some examples, the transducer 212 lays in a first plane P1 and the speaker enclosure 214 lays in a second plane P2. To that end, when the transducer 212 is coupled to the speaker enclosure 214, the first plane P1 that the transducer 212 lays in is angled with respect to the second plane P2 that the speaker enclosure 214 lays in. This “wedge” design of the transducer 212 with respect to the speaker enclosure 214 can facilitate a sealing of the rubber cap 216 with respect to the speaker enclosure 214 to further dampen the vibrations of the speaker enclosure 214 that are generated by the transducer 212.

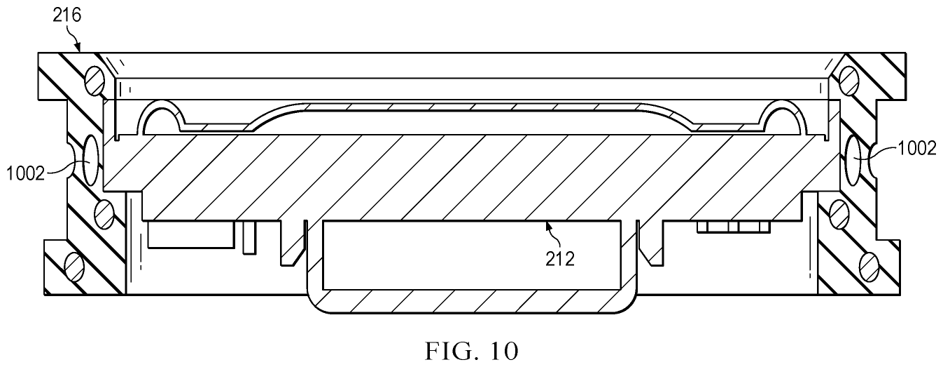

FIG. 10 illustrates a cross-sectional view of the rubber cap 216 coupled to the transducer 212. In some examples, the rubber cap 216 can further include microinjections of a gas, at points 1002. The microinjections of the gas can be at any location within the rubber cap 216. The microinjections can include nitrogen. The microinjections can provide additionally flexibility to the rubber cap 216. The microinjections can facilitate a sealing of the rubber cap 216 with respect to the speaker enclosure 214 to further dampen the vibrations of the speaker enclosure 214 that are generated by the transducer 212. In some examples, when the transducer 212 is coupled to the speaker enclosure 214, the first plane P1 that the transducer 212 lays in is angled with respect to the second plane P2 that the speaker enclosure 214 lays in and further the rubber cap 216 can further include microinjections of a gas to further dampen the vibrations of the speaker enclosure 214 that are generated by the transducer 212.

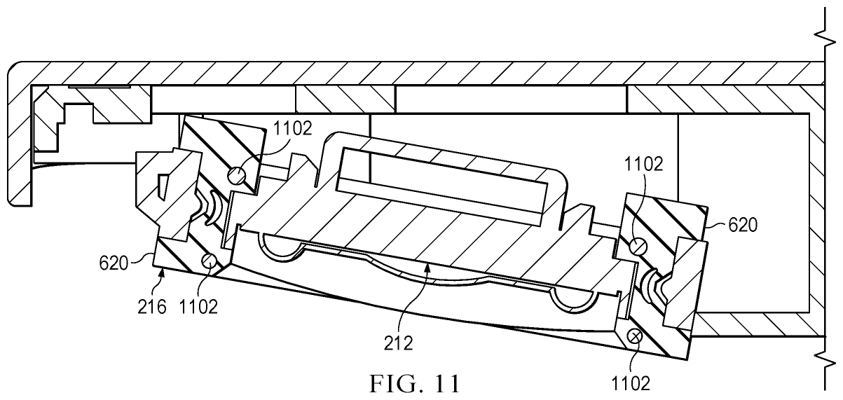

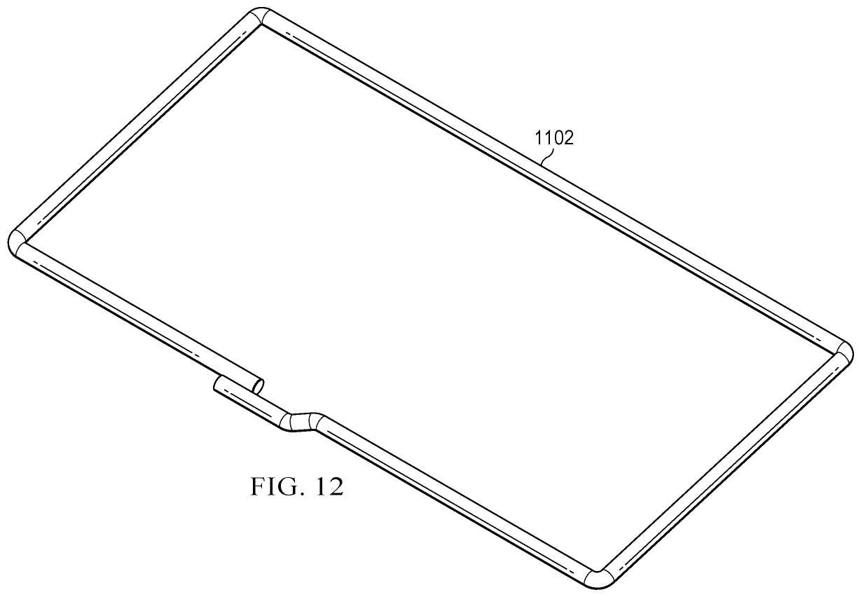

FIG. 11 illustrates a cross-sectional view of the rubber cap 216 coupled to the transducer 212. In some examples, the rubber cap 216 can further include molding springs 1102 (also shown in FIG. 12). The molding springs 1102 can be positioned within the edges 620 of the rubber cap 216; however, the molding springs 1102 can be positioned within any part of the rubber cap 216. The molding springs 1102 apply an elastic force of the rubber cap 216 against the transducer 212. The molding springs 1102 can facilitate a sealing of the rubber cap 216 with respect to the speaker enclosure 214 to further dampen the vibrations of the speaker enclosure 214. In some examples, the molding springs 1102 can further minimize application of force against the transducer 212 to maintain a desired performance level of the transducer 212.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated other-wise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A speaker module for an information handling system, including:
a speaker enclosure, including:
a recessed portion;
a transducer, including:
a top surface;
a bottom surface positioned opposite to the top surface;
a perimeter surface positioned between the top surface and the bottom surface;
a rubber cap including:
a top side;
a bottom side positioned opposite to the top side; and
a plurality of edges extending between the top side and the bottom side, wherein the plurality of edges define an inside perimeter of the rubber cap and include a slot extending along the inside perimeter of the rubber cap,
wherein, the transducer is coupled to the rubber cap such that the rubber cap surrounds the transducer and the perimeter surface of the transducer is positioned within the slot of the plurality of edges of the rubber cap,
wherein, the transducer is coupled to the speaker enclosure such that the transducer is positioned within the recessed portion of the speaker enclosure and the rubber cap is positioned between the transducer and the speaker.

2. The speaker module of claim 1, wherein
the plurality of edges further define an outside perimeter of the rubber cap,
the recessed portion of the speaker enclosure includes a plurality of walls, and
transducer is coupled to the speaker enclosure such that the transducer is positioned within the recessed portion of the speaker enclosure and the outside perimeter of the rubber cap is in contact with the plurality of walls of the recessed portion to position the rubber cap between the transducer and the speaker enclosure.

3. The speaker module of claim 1, wherein the transducer further includes a diaphragm, wherein the top side of the rubber cap includes an egress, and wherein the transducer is coupled to the rubber cap such that the diaphragm of the transducer is positioned within the egress of the top side of the rubber cap.

4. The speaker module of claim 2, wherein the transducer is coupled to the speaker enclosure such that the transducer is positioned within the recessed portion of the speaker enclosure and the outside perimeter of the rubber cap is in contact with the plurality of walls of the recessed portion to position the rubber cap between the transducer and the speaker to dampen vibrations of the speaker enclosure that are generated by the transducer.

5. The speaker module of claim 1, wherein the transducer is coupled to the speaker enclosure such that the transducer lays in a first plane angled with respect to a second plane the speaker enclosure lays in.

6. The speaker module of claim 1, wherein the rubber cap further includes microinjections of a gas.

7. The speaker module of claim 6, wherein the gas is nitrogen.

8. The speaker module of claim 1, wherein the rubber cap further includes molding springs positioned within the edges of the rubber cap to apply an elastic force of the rubber cap against the transducer.

9. A speaker module for an information handling system, including:
a speaker enclosure, including:
a recessed portion, the recessed portion including a plurality of walls;
a transducer, including:
a top surface;
a bottom surface positioned opposite to the top surface;
a perimeter surface positioned between the top surface and the bottom surface;
a rubber cap including:
a top side;
a bottom side positioned opposite to the top side; and
a plurality of edges extending between the top side and the bottom side, wherein a first edge of the plurality of edges is opposite to a third edge of the plurality of edges, and a second edge of the plurality of edges is opposite to a fourth edge of the plurality of edges, wherein the plurality of edges define an inside perimeter of the rubber cap and an outside perimeter of the rubber cap, wherein the plurality of edges include a slot extending along the inside perimeter of the rubber cap,
wherein the transducer is coupled to the rubber cap such that the rubber cap surrounds the transducer and the perimeter surface of the transducer is positioned within the slot of the plurality of edges of the rubber cap,
wherein the transducer is coupled to the speaker enclosure such that the transducer is positioned within the recessed portion of the speaker enclosure and the outside perimeter of the rubber cap is in contact with the plurality of walls of the recessed portion to position the rubber cap between the transducer and the speaker enclosure.

10. The speaker module of claim 9, wherein the transducer further includes a diaphragm, wherein the top side of the rubber cap includes an egress, and the transducer is coupled to the rubber cap such that the diaphragm of the transducer is positioned within the egress of the top side of the rubber cap.

11. The speaker module of claim 9, wherein the transducer is coupled to the speaker enclosure such that the transducer is positioned within the recessed portion of the speaker enclosure and the outside perimeter of the rubber cap is in contact with the plurality of walls of the recessed portion to position the rubber cap between the transducer and the speaker enclosure to dampen vibrations of the speaker enclosure that are generated by the transducer.

12. The speaker module of claim 9, wherein the transducer is coupled to the speaker enclosure such that the transducer lays in a first plane angled with respect to a second plane the speaker enclosure lays in.

13. The speaker module of claim 9, wherein the rubber cap further includes microinjections of a gas.

14. The speaker module of claim 9, wherein the gas is nitrogen.

15. The speaker module of claim 9, wherein the rubber cap further includes molding springs positioned within the edges of the rubber cap to apply an elastic force of the rubber cap against the transducer.

16. A speaker module for an information handling system, including:
a speaker enclosure, including:
a recessed portion, the recessed portion including a plurality of walls;
a transducer, including:
a top surface;
a bottom surface positioned opposite to the top surface;
a perimeter surface positioned between the top surface and the bottom surface;
a diaphragm;
a rubber cap including:
a top side including an egress;
a bottom side positioned opposite to the top side; and
a plurality of edges extending between the top side and the bottom side, wherein a first edge of the plurality of edges is opposite to a third edge of the plurality of edges, and a second edge of the plurality of edges is opposite to a fourth edge of the plurality of edges, wherein the plurality of edges define an inside perimeter of the rubber cap and an outside perimeter of the rubber cap, wherein the plurality of edges include a slot extending along the inside perimeter of the rubber cap,
wherein the transducer is coupled to the rubber cap such that i) the rubber cap surrounds the transducer and the perimeter surface of the transducer is positioned within the slot of the plurality of edges of the rubber cap, and ii) the diaphragm of the transducer is positioned within the egress of the top side of the rubber cap,
wherein the transducer is coupled to the speaker enclosure such that the transducer is positioned within the recessed portion of the speaker enclosure and the outside perimeter of the rubber cap is in contact with the plurality of walls of the recessed portion to position the rubber cap between the transducer and the speaker enclosure to dampen vibrations of the speaker enclosure that are generated by the transducer.

17. The speaker module of claim 16, wherein the transducer is coupled to the speaker enclosure such that the transducer lays in a first plane angled with respect to a second plane the speaker enclosure lays in.

18. The speaker module of claim 16, wherein the rubber cap further includes microinjections of a gas.

19. The speaker module of claim 18, wherein the gas is nitrogen.

20. The speaker module of claim 16, wherein the rubber cap further includes molding springs positioned within the edges of the rubber cap to apply an elastic force of the rubber cap against the transducer.
